(19) United States
(12) Patent Application Publication
(10) Pub. No.: US 2010/0283369 A1
(43) Pub. Date: Nov. 11, 2010

(54) LED bulb and lamp holder thereof

(75) Inventor: Chin-Yi Chen, Taipei County (TW)

Correspondence Address: BACON & THOMAS, PLLC, 625 SLATERS LANE, FOURTH FLOOR, ALEXANDRIA, VA, 22314-1176, US

(73) Assignee: YI-JIN INDUSTRIAL CO., LTD., Taipei County (TW)

(21) Appl. No.: 12/453,258

(22) Filed: May 5, 2009

(51) Int. Cl. H01J 61/94

(52) U.S. Cl. 313/1

(57) ABSTRACT

The present invention discloses an LED bulb and its lamp holder. The lamp holder is provided for guiding light sources. The light sources emitted from single LEDs in the LED bulb is diffused uniformly and merged with each other to provide good illuminations. A light guide pipe is integrated with an internal periphery of a transparent casing of the lamp holder and disposed at a position opposite to each single LED. A root portion of the light guide pipe has a larger external diameter at a position proximate to the transparent casing, and the root portion is extended to an end portion proximate to a position of the LED having a tapered external diameter to form a conical shape, such that the light source produced by each single LED can be passed through the corresponding light guide pipe and uniformly diffused to transparent casing, and then to the outside.

### BACKGROUND OF THE INVENTION

1. Field of the Invention

The present invention relates to a bulb assembly technology, in particular to a light emitting diode (LED) bulb using a plurality of single LEDs as a light source, and a lamp holder of the LED bulb.

2. Description of the Related Art

In recent years, LED has been used extensively for illumination, since the LED has the advantages of a better power-saving capability and a longer using life than other light emitting devices. However, the luminance of single LEDs is limited by the bottleneck of the technology to meet the requirement of an increasingly higher power, and thus a larger number of single LEDs are used for increasing the luminance of the illumination lamps. Unlike traditional light emitting devices, the single LED produces a light source with the characteristic of focusing the light source in a specific area and at a specific angle. If a plurality of single LEDs are installed on an illumination lamp, there will be a multiple of light sources and a plurality of light spots causing a non-uniform illumination easily, and an illuminated object will have a multiple of shadows to result in a blurred image for viewers or even harm the vision of the viewers.

With reference to FIGS. 1 and 2 for schematic views of a conventional lamp including a plurality of single LEDs, a plurality of refractive line patterns 92 formed on a lamp holder 91 as shown in FIG. 1 are generally used as a technical measure to overcome the shortcoming of the plurality of single LEDs 90 having a multiple of light sources of an illumination. The refractive line patterns 92 can diffuse the light sources produced by each single LED 90 by refractions. In FIG. 2, a mist finish process is applied to the lamp holder 91, such that the light sources produced by each single LED 90 can be diffused and illuminated softly.

However, the result of the improvement made by the aforementioned conventional measures for diffusing light sources is not as good as expected, and the issues of having a multiple of light sources, a multiple of light spots, a non-uniform illumination, and a multiple of shadows of an illuminated object still cannot be suppressed or overcome effectively. In view of these shortcomings, the inventor of the present invention based on years of experience in the related industry to conduct extensive researches and experiments, and finally found out the main reason for the poor result of the improvement made so far. When the plurality of single LEDs produce light sources, a plurality of light beams are projected onto an internal surface of the lamp holder to produce light spots and flare spots, and dark areas with insufficient luminance are formed between the light spots, such that when the light spots are produced, the diffusion produced by the refractive line patterns or the mist finish surface of the lamp holder has limited effects.

Therefore, the inventor of the present invention adopted a bulb having a plurality of single LEDs and designed an LED bulb and a lamp holder to overcome the shortcoming of an illumination having a multiple of light sources.

### SUMMARY OF THE INVENTION

Therefore, it is a primary objective of the present invention to diffuse and merge the light sources emitted from a plurality of single LEDs in an LED bulb.

To achieve the foregoing objective, the present invention provides an LED bulb comprising a lamp base, a lamp holder mounted onto the lamp base, a plurality of single LEDs installed at a coupling end of the lamp base and corresponding to the lamp holder, a circuit device installed in the lamp base for driving each single LED to produce a light source, and a connector installed at an end of the lamp base for electrically connecting the circuit device to an external bulb socket.

The lamp holder includes a transparent casing mounted onto the lamp base having a plurality of single LEDs, a light guide pipe installed to an internal periphery of the transparent casing and at a position opposite to each single LED, wherein a root portion of each light guide pipe has a larger external diameter at a position proximate to the transparent casing, and at least one side coupled to a root portion of an adjacent light guide pipe, and each light guide pipe is extended from the root portion to an end portion proximate to the single LED at the position having a tapered external diameter to form a conical shape, and the end portion of the light guide pipe has an embedding groove provided for embedding a light source generating end of a corresponding single LED, such that the light source produced by each single LED can be passed through the corresponding light guide pipe and uniformly diffused to the transparent casing and then to the outside.

Each light guide pipe is installed by integrating each light guide pipe with the transparent casing or integrally forming each light guide pipe to produce a light guide module first and then creating a recession at the backside of the light guide module and opposite to each light guide pipe, and finally installing the light guide module at the internal surface of the transparent casing, and the aforementioned technical measures taken can produce a light guide effect.

If each light guide pipe is integrally formed with the transparent casing by molding injection, a plurality of expanded-diameter protrusions or light guide bodies can be installed at the root portion of each light guide pipe to facilitate the light guide and diffuse the light more uniformly.

Compared with the prior art, the LED bulb and the lamp holder in accordance with the present invention refract the light sources produced the single LEDs through the light guide pipes before light enters into the transparent casing, and the light can be diffused uniformly by the total reflection effect and guided to the internal surface of the transparent casing, without forming and gathering light spots or flare spots on the internal surface of the transparent casing (or the lamp holder), so as to provide the best illumination effect.

### BRIEF DESCRIPTION OF THE DRAWINGS

FIG. 1 is a schematic view of a conventional lamp including a plurality of single LEDs;

FIG. 2 is another schematic view of a conventional lamp including a plurality of single LEDs;

FIG. 3 is a partial cross-sectional view of a first preferred embodiment of the present invention;

FIG. 4 is an exploded view of a first preferred embodiment of the present invention;

FIG. 5 is a side view of an internal surface of a lamp holder in accordance with a second preferred embodiment of the present invention;

FIG. 6 is an exploded view of a second preferred embodiment of the present invention;

FIG. 7 is a partial cross-sectional view of a second preferred embodiment of the present invention;

FIG. 8 is an exploded view of a third preferred embodiment of the present invention;

FIG. 9 is a partial cross-sectional view of a third preferred embodiment of the present invention;

FIG. 10 is a schematic view of an internal surface of a lamp holder in accordance with a fourth preferred embodiment of the present invention;

FIG. 11 is a schematic view of an internal surface of a lamp holder in accordance with a fifth preferred embodiment of the present invention; and

FIG. 12 is a front view of a preferred embodiment of the present invention.

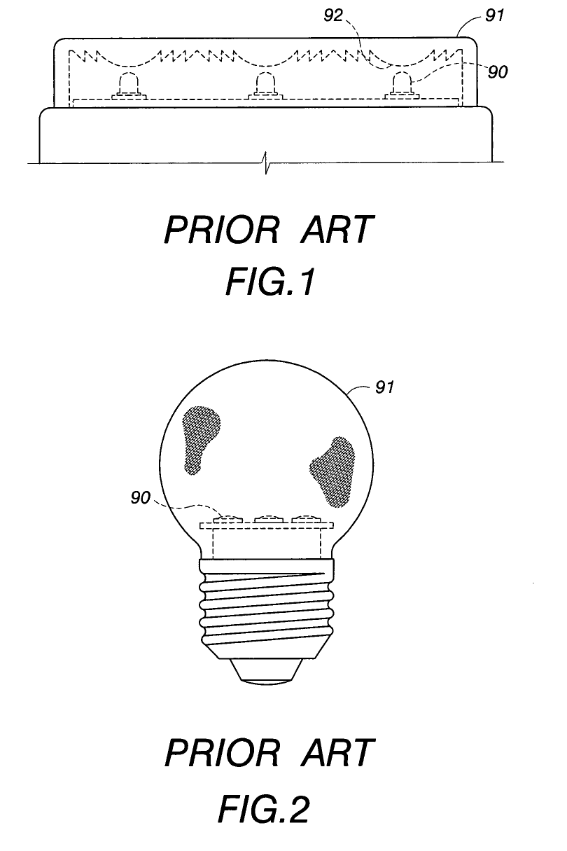

### DETAILED DESCRIPTION OF THE PREFERRED EMBODIMENTS

The present invention will now be described in more detail hereinafter with reference to the accompanying drawings that show various embodiments of the invention as follows.

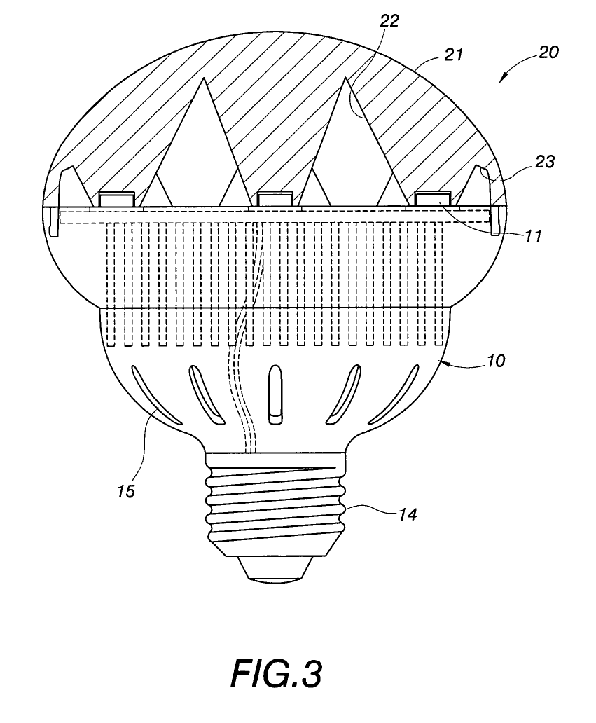

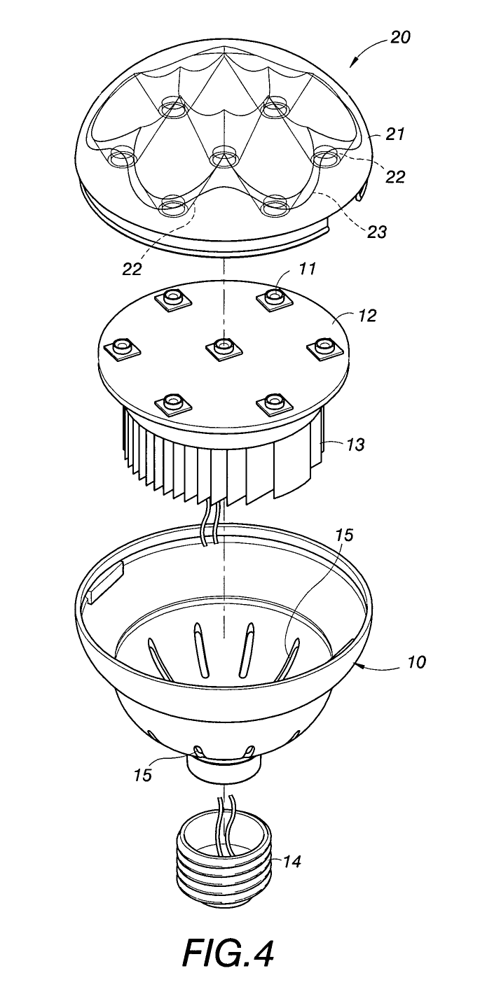

With reference to FIGS. 3 and 4 for a partial cross-sectional view and an exploded view of an LED bulb in accordance with a first preferred embodiment of the present invention respectively, the LED bulb comprises a lamp base 10 and a lamp holder 20 mounted onto the lamp base 10.

The lamp base 10 includes a plurality of single LEDs 11 installed at a coupling end corresponding to the lamp holder 20, a circuit device 12 installed in the lamp base 10 for driving each single LED 11 to produce a light source, a heat dissipating fin module 13 installed at the bottom of the circuit device, a connector 14 installed at an end of the lamp base 10 for electrically connecting the circuit device 12 with an external bulb socket, and a plurality of heat dissipating through holes 15 disposed at the periphery of the lamp base 10.

A light guide pipe 22 is integrally extended from an internal periphery of the transparent casing 21 of the lamp holder 20 and at a position opposite to each single LED 11, and a root protrusion of the light guide pipe 22 has a larger external diameter at the position of the root portion proximate to the transparent casing 11, and at least one side is coupled to a root portion of an adjacent light guide pipe 22. and each light guide pipe is extended from the root portion to an end portion proximate to the single LED 11 at a position with a tapered external diameter to form a substantially conical shape (such as a conical shape or a multilateral conical shape, and the conical shape is adopted in the figure for illustrating this embodiment), and the transparent casing 21 of this preferred embodiment is in a circular arc shape, and each of the light guide pipes 22 is integrally formed with the transparent casing 21, and some of the light guide pipes 22 are arranged into a circular shape, and a light guide body 23 is extended slantingly from the connecting position of the periphery of the root portion of the circularly arranged light guide pipes 22 and the transparent casing 21, such that the intensity of the light source produced by each single LED 11 can be passed through a corresponding light guide pipe 22 and uniformly diffused to transparent casing 21 and then to the outside, so as to achieve the uniform scattering effect, while maintaining a minimal light attenuation.

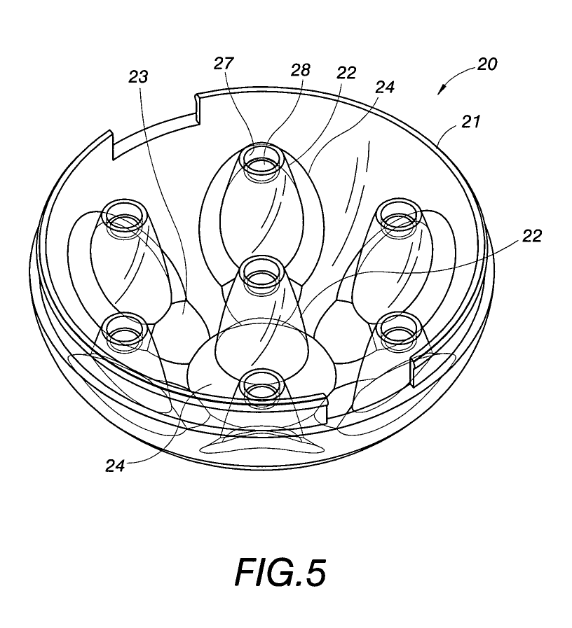

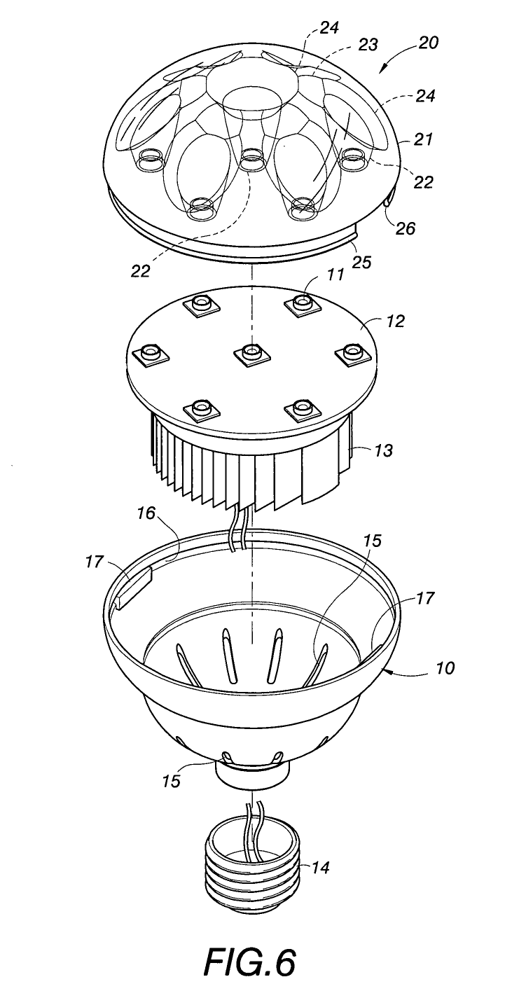

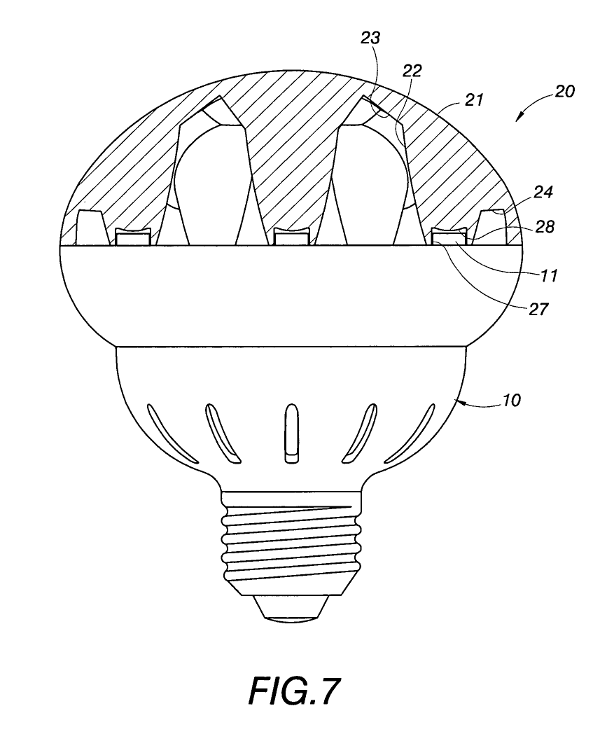

With reference to FIGS. 5 to 7 for a second preferred embodiment of the present invention, the difference of the second preferred embodiment from the first preferred embodiment resides on that adjacent light guide pipes 22 are not connected directly, and an expanded-diameter protrusion 24 is spread around from the connecting position of the root portion of each light guide pipe 22 and the transparent casing 11, and a convex arc light guide body 23 is extended from at least one side of the expanded-diameter protrusion 24, and the convex arc light guide body 23 is coupled to an expanded-diameter protrusion 24 of an adjacent light guide pipe 22.

The transparent casing 21 can be transparent, made of a transparent material or a semi-transparent material, and processed by a mist finish processing. A latch flange 25 is disposed at the periphery of the bottom of the transparent casing 21, and a latch groove 16 is disposed at the lamp base 10 and corresponding to the latch flange 25 for latching and positioning the transparent casing 21. The latch flange 25 includes at least one notch 26, and the lamp base 10 includes a stop body 17 corresponding to the notch 26 for preventing the lamp holder 20 from rotating with respect to the lamp base 10, so that the lamp base 10 and the lamp holder 20 can be assembled quickly.

In addition, an end portion of the light guide pipes 22 includes an embedding groove 27 for embedding a light source generating end of a corresponding single LED 11, and a cambered surface 28 disposed in the embedding groove 27 and at a position corresponding to the light source generating end of the single LED 11, wherein the cambered surface 28 can be integrally formed inside the embedding groove 27, or composed of a lens installed at the bottom of the embedding groove 27.

The plurality of light guide pipes 22 in this preferred embodiment are arranged in a radial shape, and one of the light guide pipes 22 is situated at the center of an internal surface of the transparent casing 21, and other light guide pipes 22 are situated around the periphery of the light guide pipe 22 at the central position.

When each single LED 11 produces a light source, the light source is refracted from the cambered surface 28 to produce a diffused light source, and the light is entered into the light guide pipe 22 directly. In the meantime, the principle of total reflection and refraction of the light drives the light source to be passed through the light guide pipe 22, the expanded-diameter protrusion 24, and the convex arc light guide body 23, and uniformly diffused to transparent casing 21 and then to the outside, such that the light sources produced by the single LEDs 11 are diffused uniformly before entering into the transparent casing 21.

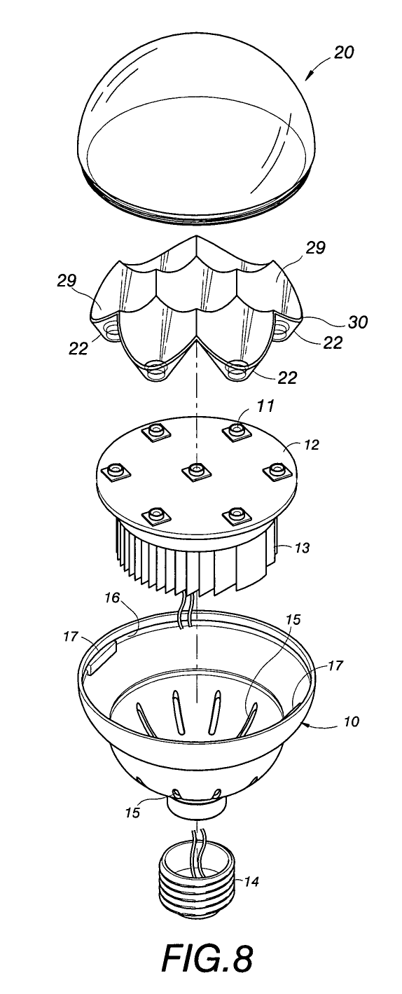

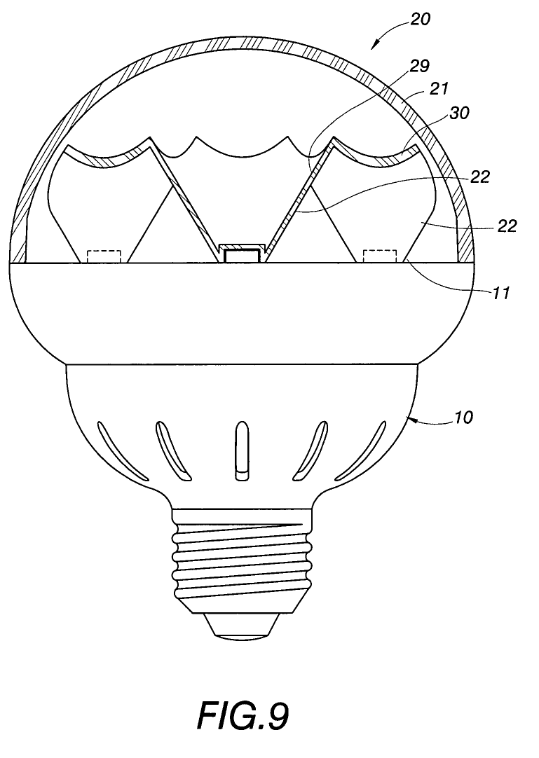

With reference to FIGS. 8 and 9 for a third preferred embodiment of the present invention, the difference of this preferred embodiment from the first preferred embodiment resides on that the plurality of light guide pipes 22 are integrally formed by mold injection to produce a light guide module 30, and then the light guide module 30 is mounted on an internal periphery of the transparent casing 21, and a recession 29 is disposed on the backside of the light guide module 30 and at a position opposite to each light guide pipe 22, such that each light guide pipe 22 is hollow, and the light source produced by each single LED 11 is passed through the corresponding light guide pipe 22 and uniformly diffused to transparent casing 21 and then to the outside, so as to achieve the uniform scattering effect while maintaining a minimal light attenuation. In the first, second and third preferred embodiments, the stylish appearance of the transparent casing 21 of the lamp holder 20 and the arrangement of the light guide pipes 22 include substantially a circular arc shaped transparent casing 21 with radially arranged light guide pipes 22. In fact, the stylish appearance of the transparent casing 21 and the arrangement of the light guide pipes 22 can be modified according to actual requirements.

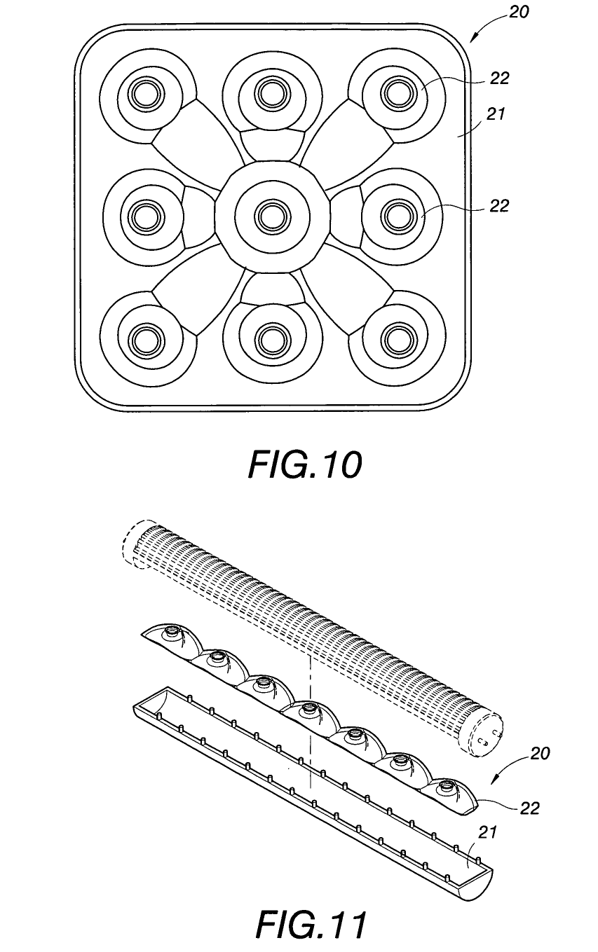

For example, an internal surface of the transparent casing 21 of the lamp holder in accordance with the fourth preferred embodiment of the present invention as shown in FIG. 10 is in a rectangular shape, and the light guide pipes 22 are arranged in a rectangular array. With reference to FIG. 11 for a schematic view of an internal surface of a lamp holder in accordance with a fifth preferred embodiment of the present invention, the transparent casing 21 of the lamp holder is in a slightly curved long bar shape, and the light guide pipes 22 are arranged into a long bar shape. In addition, this preferred embodiment further combines a heat dissipating base as indicated by the dotted line of the figure to show the shape of a fluorescent lamp tube.

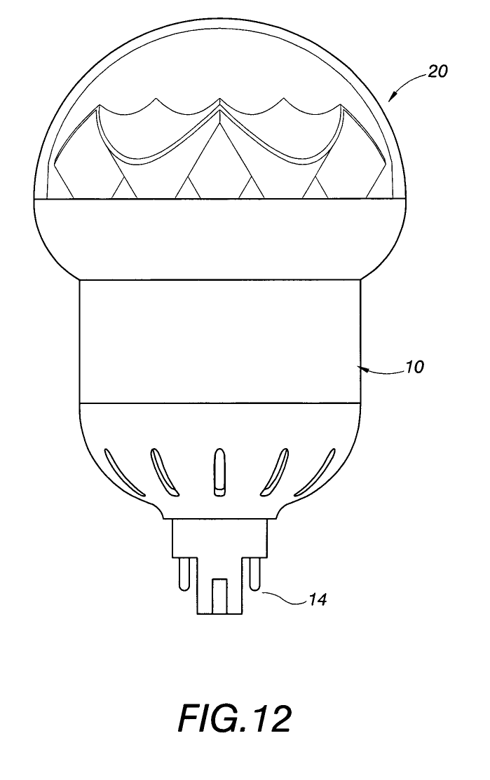

With reference to FIG. 12 for a front view of a preferred embodiment of the present invention, the difference of the fifth preferred embodiment from the first preferred embodiment resides on that the length of the lamp base 10 is larger, such that the LED bulb can be installed into a deeper position, and the connector 14 is unlike the previously disclosed screw type connector, and this preferred embodiment adopts an insert type connector 14 for plugging in an external insert type socket.

In summation of the description above, the LED bulb as described in each preferred embodiment of the present invention can drive the light sources produced by a plurality of single LEDs to be guided by the light guide pipes and the expanded-diameter protrusion, refracted from the convex arc light guide body, diffused uniformly by the total reflection effect, and guided to the internal surface of the transparent casing, before the light source enters into the transparent casing, so as to provide a better illumination effect.

While the invention has been described by means of specific embodiments, numerous modifications and variations could be made thereto by those skilled in the art without departing from the scope and spirit of the invention set forth in the claims.

What is claimed is:

1. A lamp holder, comprising: a transparent casing, installed onto a lamp base with a plurality of single LEDs, and including a light guide pipe installed at an internal periphery of the transparent casing and corresponding to each single LED, and each light guide pipe having a root portion proximate to a position of the transparent casing having a larger external diameter, and at least one side connected to the root portion of an adjacent light guide pipe, and the root portion of each light guide pipe being extended to an end portion proximate to the single LED having a tapered external diameter to form a conical shape, such that a light source produced by each single LED can be diffused through the corresponding light guide pipe to the transparent casing and then dispersed to the outside.

2. The lamp holder of claim 1, wherein the transparent casing in a circular arc shape, and the plurality of light guide pipes are integrally formed with the transparent casing and arranged around the transparent casing into a circular shape.

3. The lamp holder of claim 2, wherein the plurality of light guide pipes arranged in a circular shape include a light guide body extended slantingly from a connecting position of a periphery of a root portion of the light guide pipes and the transparent casing.

4. The lamp holder of claim 2, wherein each light guide pipe includes an expanded-diameter protrusion disposed at a connecting position of the root portion and the transparent casing and spread out to different direction, and a convex arc light guide body disposed on at least one side of the expanded-diameter protrusion, and coupled to an expanded-diameter protrusion of an adjacent light guide pipe.

5. The lamp holder of claim 1, wherein the light guide pipe has an embedding groove disposed at an end portion of the light guide pipe for embedding an light source generating end of the single LED.

6. The lamp holder of claim 1, wherein the plurality of light guide pipes are formed integrally into a light guide module by a mold injection, and then installed at the internal periphery of the transparent casing, and a recession is disposed on a backside of the light guide module and at a position opposite to each light guide pipe, such that each light guide pipe is hollow.

7. The lamp holder of claim 6, wherein the light guide pipe has an embedding groove disposed at an end portion of the light guide pipe for embedding an light source generating end of the single LED.

8. The lamp holder of claim 1, wherein the transparent casing in a rectangular shape or a long bar shape.

9. The lamp holder of claim 8, wherein the plurality of light guide pipes are formed integrally into a light guide module by a mold injection, and then installed at the internal periphery of the transparent casing, and a recession is disposed on a backside of the light guide module and at a position opposite to each light guide pipe, such that each light guide pipe is hollow.

10. The lamp holder of claim 9, wherein the light guide pipe has an embedding groove disposed at an end portion of the light guide pipe for embedding an light source generating end of the single LED.

11. A light emitting diode (LED) bulb, comprising a lamp base, a lamp holder installed onto the lamp base, a plurality of single LEDs installed at an coupling end of the lamp base and corresponding to the lamp holder, a circuit device installed in the lamp base for driving each single LED to produce a light source, and a connector installed at an end of the lamp base for electrically connecting the circuit device to an external bulb socket, characterized in that:
a light guide pipe is installed on an internal surface of the transparent casing of the lamp holder and at a position opposite to each single LED, and a root portion of each light guide pipe has a larger external diameter at a position proximate to the transparent casing, at least one side is coupled to a root portion of an adjacent light guide pipe, and each light guide pipe is extended from the root portion to an end portion proximate to the single LED at a position with a tapered external diameter to form a conical shape, such that a light source produced by each single LED can be passed through the corresponding light guide pipe and uniformly diffused to the transparent casing and then to the outside.

12. The LED bulb of claim 11, wherein the transparent casing is in a circular arc shape, and the plurality of light guide pipes are integrally formed with the transparent casing and arranged into a circular shape.

13. The LED bulb of claim 12, wherein the plurality of light guide pipes arranged in a circular shape include a light guide body extended slantingly from a connecting position of a periphery of a root portion of the light guide pipes and the transparent casing.

14. The LED bulb of claim 12, wherein each light guide pipe includes an expanded-diameter protrusion disposed at a connecting position of the root portion and the transparent casing and spread out to different direction, and a convex arc light guide body disposed on at least one side of the expanded-diameter protrusion, and coupled to an expanded-diameter protrusion of an adjacent light guide pipe.

15. The LED bulb of claim 11, wherein the light guide pipe has an embedding groove disposed at an end portion of the light guide pipe for embedding an light source generating end of the single LED.

16. The lamp holder of claim 11, wherein the plurality of light guide pipes are formed integrally into a light guide module by a mold injection, and then installed at the internal periphery of the transparent casing, and a recession is disposed on a backside of the light guide module and at a position opposite to each light guide pipe, such that each light guide pipe is hollow.

17. The lamp holder of claim 16, wherein the light guide pipe has an embedding groove disposed at an end portion of the light guide pipe for embedding an light source generating end of the single LED.

18. The lamp bulb of claim 11, wherein the transparent casing is in a rectangular shape or a long bar shape.

19. The lamp holder of claim 18, wherein the plurality of light guide pipes are formed integrally into a light guide module by a mold injection, and then installed at the internal periphery of the transparent casing, and a recession is disposed on a backside of the light guide module and at a position opposite to each light guide pipe, such that each light guide pipe is hollow.

20. The lamp holder of claim 18, wherein the light guide pipe has an embedding groove disposed at an end portion of the light guide pipe for embedding an light source generating end of the single LED.

21. The lamp bulb of claim 11, wherein the transparent casing includes a latch flange, and the lamp base includes a latch groove corresponding to the latch flange for latching and positioning the transparent casing, and the latch flange includes at least one notch, and the lamp base includes a stop body corresponding to the notch.

22. The lamp bulb of claim 11, wherein the lamp base includes a connector electrically connected to an external bulb socket, and the connector is an insert type connector or a screw-type connector.

23. The lamp bulb of claim 11, wherein the circuit device includes a heat dissipating fin module, and the lamp base includes a plurality of heat dissipating through holes.
